(19) United States
(12) Patent Application Publication
(10) Pub. No.: US 2022/0122456 A1
(43) Pub. Date: Apr. 21, 2022

(54) EXPLANATION OF ERRATIC DRIVING BEHAVIOR

(71) Applicant: HERE Global B.V., Eindhoven (NL)

(72) Inventors: Jerome Beaurepaire, Berlin (DE); Leon Stenneth, Chicago, IL (US); Jeremy Michael Young, Chicago, IL (US)

(21) Appl. No.: 17/075,078

(22) Filed: Oct. 20, 2020

(51) Int. Cl. G08G 1/0967; G06Q 50/26; G06F 16/29; G10L 15/26; H04W 4/46; G01S 17/89; G01S 13/89; G05D 1/02; G06K 9/00; G06F 3/16; G10L 15/22; G10L 15/18

(52) U.S. Cl. CPC G08G 1/096791; G06Q 50/265; G06F 16/29; G10L 15/26; H04W 4/46; G01S 17/89; G06N 20/00; G05D 1/0274; G06K 9/00228; G06F 3/167; G10L 15/22; G10L 15/1815; G01S 13/89

(57) ABSTRACT

System and methods are provided for generating answers to questions by drivers or passengers of autonomous vehicles in order to better understand the behaviors of other vehicles around them by being able to get contextual answers to behavioral queries. The system receives a user inquiry from a user of the vehicle, the user inquiry related to a behavior of another vehicle in the vicinity of the vehicle. The system analyzes sensor data acquired by the vehicle for a period of time preceding the inquiry and generates an answer to the inquiry based on contextual information of the inquiry, the analysis of the sensor data, and mapping information.

### FIELD

The following disclosure relates to navigation devices or services.

### BACKGROUND

Smart personal assistants and virtual assistants may be used for a variety of tasks by responding to voice commands or questions. These virtual assistants may also be used in a vehicle for voice commands and personal assistant tasks. Virtual assistants typically allow a user to connect a personal device to a vehicle and utilize many of the device's apps, such as map navigation, text messaging and online music streaming. The virtual assistant features may function using a display screen in a vehicle as well as through voice commands. A user may, for example, press a button or say a simple initiation prompt and ask to play music, check, and adjust appointments, calendar, keep up to date with the news cycle, or order various products among other tasks. The abilities of these virtual assistants, in other words, are ported to a vehicle's system making it easier to, for example, interact with the virtual assistants while operating the vehicle. The functionality of the virtual assistants, however, is very similar to a standalone virtual assistant as provided, for example by a typical smartphone.

Certain virtual assistants have improved on this basic functionality by allowing a user to interact with your car's features by providing specific APIs or functionality. As an example, a user may state “I need gas” and the vehicle's virtual assistant may provide recommendations for nearby gas stations. In addition, virtual vehicle assistants may provide directions, ask for restaurant recommendations, find nearby parking, search business hours, etc. Virtual vehicle assistants may locate the next EV charging station, check the weather forecast, provide information about points of interests as the vehicle passes them, and help a user stay on top of flights, stocks, sport scores etc. These queries take the form of typical questions that may be answered by the virtual vehicle assistant such as “Will it rain today?” “What is that building on the left?” “How long till we get there?” etc. In addition, these virtual vehicle assistants may allow a user to control some functionality of a vehicle such as “Turn on the AC” “Increase the speed of the wipers” “Defrost the side mirrors” “Lower the rear windows” etc. For autonomous or semi-autonomous vehicles, a virtual vehicle assistant may provide entertainment options to provide an interactive experience for passengers of the vehicle.

Current virtual vehicle assistants are thus able to provide simple answers that standard virtual assistants also provide but with some additional functionality by being integrated into or with a vehicle. Current virtual vehicle assistants, however, are unable to make use of much of the sensor data acquired and used by autonomous vehicle when navigating a roadway. Current virtual vehicle assistants, for example, cannot assist drivers or passengers in answers to questions related to traffic or vehicles around them.

### SUMMARY

In an embodiment, a method is provided for analyzing an environment around a vehicle to be able to provide an explanation about what is happening in the environment, the method includes receiving, by a processor, an inquiry from a user of the vehicle, the inquiry related to a behavior of another vehicle in a vicinity of the vehicle, analyzing, by the processor, sensor data acquired by the vehicle for a period of time preceding the inquiry, generating, by the processor, an answer to the inquiry based on contextual information of the inquiry, geographic map data, and the analysis of the sensor data, and providing, by the processor, the answer to the inquiry.

In an embodiment, a system is provided for providing answers to user inquiries in a first vehicle. The system includes a geographic database, one or more sensors, a user interface, and a controller. The geographic database is configured to store map data for a roadway network. The one or more sensors are configured to acquire sensor data for an environment around the first vehicle. The user interface is configured to receive an inquiry from a user of a first vehicle regarding an operation of a second vehicle in a vicinity of the first vehicle and provide an answer. The controller is configured to analyze the inquiry, the sensor data, and the map data and generate the answer to the inquiry based on the analysis.

In an embodiment, an apparatus is provided for providing a response to a user query about what is happening around a vehicle. The apparatus includes at least one processor; and at least one memory including computer program code for one or more programs; the at least one memory configured to store the computer program code that is configured to, with the at least one processor, to cause the at least one processor to: acquire sensor data for an environment around a mobile device; receive an inquiry from a user interface; determine a context of the inquiry based on the sensor data; generate an answer to the inquiry using the context, the sensor data, and geographic data stored in a geographic database; and provide the answer with the user interface.

### BRIEF DESCRIPTION OF THE DRAWINGS

Exemplary embodiments of the present invention are described herein with reference to the following drawings.

FIG. 1 depicts an example of a system for analyzing the environment around a vehicle in real time to be able to give explanation about what is happening or to respond to a specific user query about what is happening around the vehicle according to an embodiment.

FIG. 2 depicts an example of a workflow for analyzing an environment around a vehicle in real time to be able to provide an explanation about what is happening in the environment according to an embodiment.

FIG. 3 depicts an example scenario for a user inquiry about what is happening in the environment.

FIG. 4 depicts an example computer vision image on a roadway.

FIG. 5 depicts an example server of FIG. 1.

FIG. 6 depicts an example map for the geographic database of FIG. 1.

FIG. 7 depicts an example structure of the geographic database.

FIG. 8 depicts an example structure of the geographic database.

FIG. 9 depicts an example device of FIG. 1.

### DETAILED DESCRIPTION

Embodiments described herein provide systems and methods that provide an ability for drivers or passengers of autonomous vehicles to better understand the behaviors of other vehicles around them by being able to get contextual answers to behavioral queries. The system receives a user inquiry from a user of the vehicle, the user inquiry related to a behavior of another vehicle in the vicinity of the vehicle. The system analyzes sensor data acquired by the vehicle for a period of time preceding the inquiry and generates an answer to the inquiry based on contextual information from the analysis of the sensor data and mapping information.

The systems and methods described herein are applicable to navigation systems and vehicles in general, but more specifically navigation systems that support fully highly assisted, autonomous, or semi-autonomous vehicles. A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the position of the vehicle and routing instructions. Advanced driver-assistance system (ADAS) vehicles include one or more partially automated systems in which the vehicle alerts the driver. The features may be used to provide alerts to the operator regarding upcoming features. ADAS vehicles may include adaptive cruise control, automated braking, or steering adjustments to keep the driver in the correct lane. ADAS vehicles may issue warnings for the driver based on the position of the vehicle either on a roadway or within a road network system. There are five typical levels of autonomous driving. For level 0, the driver completely controls the vehicle at all times. For level 1, individual vehicle controls are automated, such as electronic stability control or automatic braking. For level 2, at least two controls can be automated in unison, such as adaptive cruise control in combination with lane-keeping. For level 3 the driver can fully cede control of all safety-critical functions in certain conditions. The car senses when conditions require the driver to retake control and provides a “sufficiently comfortable transition time” for the driver to do so. For level 4, the vehicle performs all safety-critical functions for the entire trip, with the driver not expected to control the vehicle at any time. For level 5, the vehicle includes humans only as passengers, no human interaction is needed or possible. Vehicles classified under Levels 4 and 5 of autonomy are considered highly and fully autonomous respectively as they can engage in all the driving tasks without human intervention

In order to operate safely and efficiently, autonomous vehicles collect data about the roadway and the environment around the vehicle. The autonomous vehicle needs sensory input devices like cameras, radar, and lasers to allow the car to identify the environment and the objects around the vehicle. Object detection is a two-part process, image classification and then image localization. Image classification is determining what the objects in the image are, like a car or a person, while image localization is providing the specific location of these objects. Vehicles also have to perform object detection in real-time in order to detect objects approaching quickly and avoid them. The data obtained may be combined with 3D maps to spot objects like traffic lights, vehicles, and pedestrians to help make decisions in real time.

An autonomous vehicle learns to operate a vehicle by identifying these objects and roadway features and then performing various actions in response. A typical self-driving workflow includes sensor data, a perception layer that interprets that data, an intention-prediction model that understands how agents might react in future, a path-planning module, and a vehicle-control stack to implement decisions. The process is complex and may be difficult if not impossible for a user to comprehend in real-time. As such, when a user enters an autonomous vehicle, the user must trust that the autonomous vehicle is making safe decisions without any explanation. In an embodiment, system and methods are provided that allow a user to ask questions about the operation of the vehicle and other vehicles on the roadway that may be answered based on the sensor data, object recognition, and prediction models that are otherwise used in the operation of the autonomous vehicle. Such queries may be directed not only to the current vehicle the user is riding in or operating, but also the actions of other vehicles on the roadway, that are, for example performing erratically. Users may desire answers to their questions instead of thinking “What is happening here?” or “Why did that person do that?” or “What is that car doing?” while operating or residing in an autonomous vehicle. Current virtual vehicle assistants do not have access to the information required to answer these questions nor the capability for identifying the context of the question.

There are multiple technical challenges for providing responses, including but not limited to understanding the query, identifying relevant data for the query, and providing an answer that satisfies the query. The following embodiments relate to several technological fields including but not limited to navigation, autonomous driving, assisted driving, traffic applications, and other location-based systems. In each of the technologies of navigation, autonomous driving, assisted driving, traffic applications, and other location-based systems, improved identification, and explanation of the behavior of other vehicles improves the ability of the vehicle to offer a safe and satisfactory ride. In addition, users of navigation, autonomous driving, assisted driving, traffic applications, and other location-based systems are more willing to adopt these systems given the technological advances in improved identification and explanation.

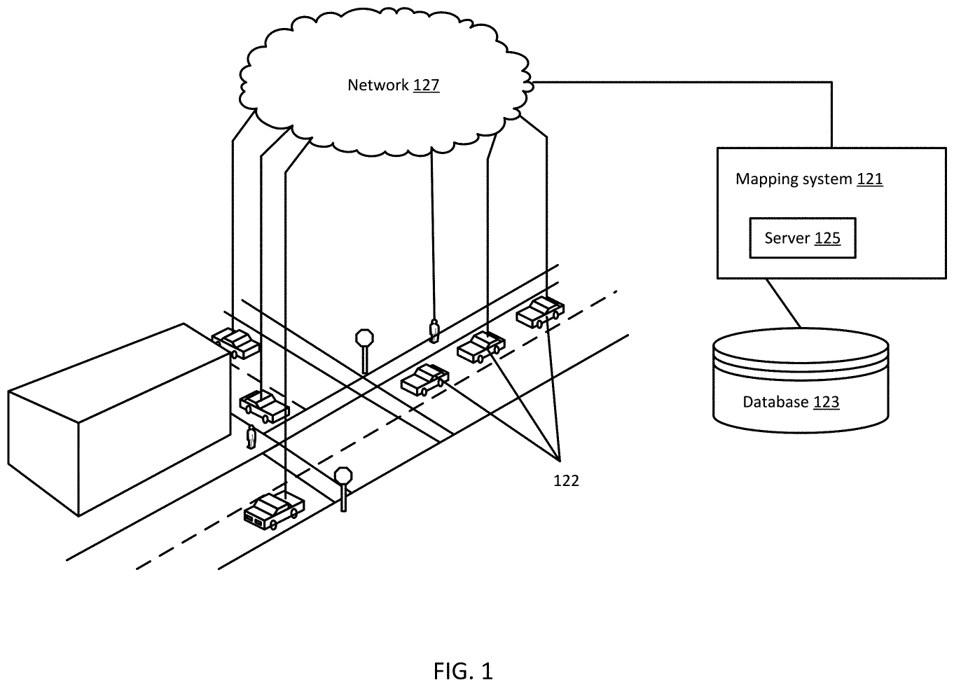

FIG. 1 illustrates an example system for analyzing the environment around a vehicle in real time to be able to give explanation about what is happening or to respond to a specific user query about what is happening around the vehicle or for a specific vehicle around the car. The system includes one or more devices 122, a network 127, and a mapping system 121. The mapping system 121 may include a database 123 (also referred to as a geographic database 123 or map database) and a server 125. Additional, different, or fewer components may be included.

The one or more devices 122 may include probe devices, probe sensors, IoT (internet of things) devices, or other devices 122 such as personal navigation devices 122 or connected vehicles. The device 122 may be a mobile device or a tracking device that provides samples of data for the location of a person or vehicle. The devices 122 may include mobile phones running specialized applications that collect location data as the devices 122 are carried by persons or things traveling a roadway system. The one or more devices 122 may include traditionally dumb or non-networked physical devices and everyday objects that have been embedded with one or more sensors or data collection applications and are configured to communicate over a network 127 such as the internet. The devices may be configured as data sources that are configured to acquire roadway data. The devices 122 may be remotely monitored and controlled. The devices 122 may be part of an environment in which each device 122 communicates with other related devices in the environment to automate tasks. The devices may communicate sensor data to users, businesses, and, for example, the mapping system 121.

In an embodiment, a device 122 is integrated in or with a vehicle. The device 122 may be implemented in a vehicle control system such as used in a HAD or ADAS vehicle. The device 122 acquire data from multiple sources including but limited to a user interface, the mapping system 121, other devices 122, other vehicles, and sensors included with or embedded in the vehicle that the device 122 is implemented with. A device 122 may provide assistance or provide commands for a vehicle control system to implement. The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. The autonomous vehicles may park themselves or move cargo between locations without a human operator. Autonomous vehicles may include multiple modes and transition between the modes. The autonomous vehicle may steer, brake, or accelerate the vehicle based on the position of the vehicle in order to avoid or comply with a routing or driving instruction from the device 122 or a remote mapping system 121.

The device 122 may be configured as a navigation system for an autonomous vehicle or a HAD. The assisted driving systems may be incorporated into the device 122. Alternatively, an assisted driving device 122 may be included in the vehicle. The assisted driving device 122 may include memory, a processor, and systems to communicate with a 122. The assisted driving vehicles may response to geographic data received from the geographic database 123 and the server 125. An autonomous vehicle or HAD may take route instructions based on a road segment and node information provided to the navigation device 122. An autonomous vehicle or HAD may be configured to receive routing instructions from a mapping system 121 and automatically perform an action in furtherance of the instructions.

The device 122 may include or be configured with a personal virtual assistant. The device 122 may be configured to run an application that allows a user to request information or provide commands. The device 122 is configured to receive a user inquiry from a user of the vehicle. In an embodiment, the user inquiry is related to a behavior of another vehicle in the vicinity of the vehicle, for example, a vehicle operating illegally or erratically. The vicinity of the vehicle may include an area of the roadway that is visible to a passenger. The vicinity may also include the area of the roadway which the device 122 is able to observe or receive data about in order to accurately identify objects and actions, and make predictions based thereon. The device 122 analyzes sensor data acquired by the vehicle for a period of time preceding the inquiry and generates an answer to the inquiry based on contextual information of the inquiry, the analysis of the sensor data, and mapping information. The mapping system 121 may acquire, analyze, store, and provide the sensor data and mapping information to the one or more devices 122.

The mapping system 121 includes at least one server 125. The server 125 may be a host for a website or web service such as a mapping service and/or a navigation service. The mapping service may provide standard maps or high definition (HD) maps generated from the geographic data of the database 123, and the navigation service may generate routing or other directions from the geographic data of the database 123. The mapping service may also provide information generated from attribute data included in the database 123. The server 125 may also provide historical, future, recent or current traffic conditions for the links, segments, paths, or routes using historical, recent, or real time collected data. The server 125 is configured to communicate with the devices 122 through the network 127. The server 125 is configured to receive a request from a device 122 for a route or maneuver instructions and generate one or more potential routes or instructions using data stored in the geographic database 123.

The server 125 is configured to acquire, analyze, and store data relating to the operation of vehicles on a roadway. The server 125 may acquire, analyze, and store data relating to user inquiries, for example from one or more devices 122. The server 125 may store the inquiries, the generated answers, and the data that was used by the device 122 to generate each answer. The server 125 may store feedback from users in order to improve the analysis and machine intelligence of the device 122. For example, the server 125 may identify that a specific question is answered poorly by the device 122. The server 125 may assist the devices 122 in understanding the question and providing a proper answer. The server 125 may also be configured to provide data to the device 122 to assist in understanding an inquiry and providing an answer. For example, the server 125 may collect data from multiple additional sources and may be able to determine, for example, a cause and effect of different actions beyond a horizon of a specific vehicle. The server 125 may be configured to calculate and identify a duration of an event for a given road segment, lane, or portion of a lane. The server 125 may thus be able to understand the extent of events beyond what a single vehicle can comprehend. The server 125 may also be configured to provide up to date information and maps to external geographic databases or mapping applications. The server 125 may also be configured to generate routes or paths between two points (nodes) on a stored map. The server 125 may be configured to encode or decode map or geographic data. An HD map and the geographic database 123 may be maintained and updated by the server 125 and/or mapping system 121. The mapping system 121 may include multiple servers 125, workstations, databases, and other machines connected together and maintained by a map developer. The mapping system 121 may be configured to acquire and process data relating to roadway or vehicle conditions. For example, the mapping system 121 may receive and input data such as vehicle data, user data, weather data, road condition data, road works data, traffic feeds, etc. The data may be historical, real-time, or predictive. The data may be stored in the HD map or in the geographic database 123.

The geographic database 123 is configured to store and provide information to and from at least the mapping system 121, server 125, and devices 122. To communicate with the systems or services, the server 125 and geographic database 123 are connected to the network 127. The server 125 may receive or transmit data through the network 127. The server 125 may also transmit paths, routes, or loss of traction risk data through the network 127. The server 125 may also be connected to an OEM cloud. The map services may be provided to vehicles via the OEM cloud or directly by the server 125 or mapping system 121. The network 127 may include wired networks, wireless networks, or combinations thereof. The wireless network may be a cellular telephone network, LTE (Long-Term Evolution), 4G LTE, a wireless local area network, such as an 802.11, 802.16, 802.20, WiMAX (Worldwide Interoperability for Microwave Access) network, DSRC (otherwise known as WAVE, ITS-G5, or 802.11p and future generations thereof), a 5G wireless network, or wireless short-range network such as Zigbee, Bluetooth Low Energy, Z-Wave, RFID and NFC. Further, the network 127 may be a public network, such as the Internet, a private network, such as an intranet, or combinations thereof, and may utilize a variety of networking protocols now available or later developed including, but not limited to transmission control protocol/internet protocol (TCP/IP) based networking protocols. The devices 122 may use Vehicle-to-vehicle (V2V) communication to wirelessly exchange information about their speed, location, heading, and roadway conditions with other devices 122 or the mapping system 121. The devices 122 may use V2V communication to broadcast and receive omni-directional messages creating a 360-degree “awareness” of other vehicles in proximity of the vehicle. Vehicles equipped with appropriate software may use the messages from surrounding vehicles to determine potential threats or obstacles as the threats develop. The devices 122 may use a V2V communication system such as a Vehicular ad-hoc Network (VANET).

The device 122 may be configured to analyze an environment around a vehicle in real time to be able to provide an explanation about what is happening in the environment. The device 122 receives a user inquiry from a user of the vehicle, the user inquiry related to a behavior of another vehicle in the vicinity of the vehicle. The device 122 analyzes sensor data acquired by the vehicle for a period of time preceding the inquiry. The device 122 may also analyze data provided by the server 125 or geographic database 123. The device 122 generates an answer to the inquiry based on contextual information from the analysis of the sensor data and mapping information provides the answer to the inquiry to the user.

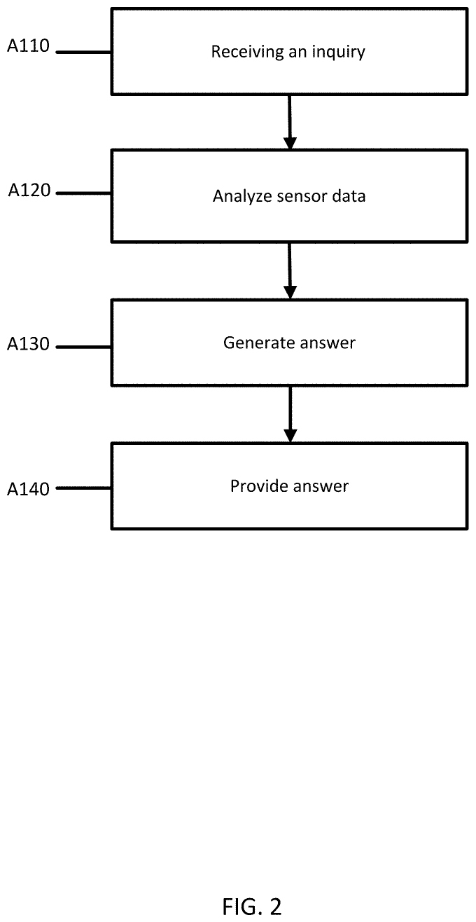

FIG. 2 illustrates an example flow chart for to analyzing an environment around a vehicle in real time to be able to provide an explanation about what is happening in the environment using the system of FIG. 1. As presented in the following sections, the acts may be performed using any combination of the components indicated in FIG. 1, 5, or 9. The following acts may be performed by the server 125, the device 122, the mapping system 121, or a combination thereof. As an example, a copy of the geographic database 123 may be updated on both the device 122 and in the mapping system 121. An autonomous vehicle may take instruction from either the device 122 or the mapping system 121 based on data stored in the geographic database 123 or acquired using one or more sensors. The device 122 or mapping system may provide answers to queries. In certain situations, the device 122 may be used as there is little to no delay for instructions to be generated and transmitted from the device 122 to the vehicle. The server 125 of the mapping system 121 may collect data from multiple devices 122 and provide this data to each of the devices 122 so that the devices are able to provide answers and/or instructions. Additional, different, or fewer acts may be provided. The acts are performed in the order shown or other orders. The acts may also be repeated. Certain acts may be skipped.

At act A110, the device 122 receives a user inquiry from a user of the device 122. The device may be embedded in or integrated into a vehicle or may be, for example a standalone device such as a smartphone. As an example, a standalone device may the be a mobile device and/or such a mobile device may be associated with other types of vehicles including bicycles as well as pedestrians. In an embodiment, the user inquiry relates to a behavior of another vehicle in the vicinity of the vehicle, for example, another vehicle that was observed by a passenger of the vehicle. The user inquiry may relate to the environment around the vehicle, for example events on the roadway concerning other vehicles, bicycles, pedestrians, etc. The device 122 may be configured with a user interface that is interactable by a user, for example by using speech recognition, image data, or other input such as a keyboard.

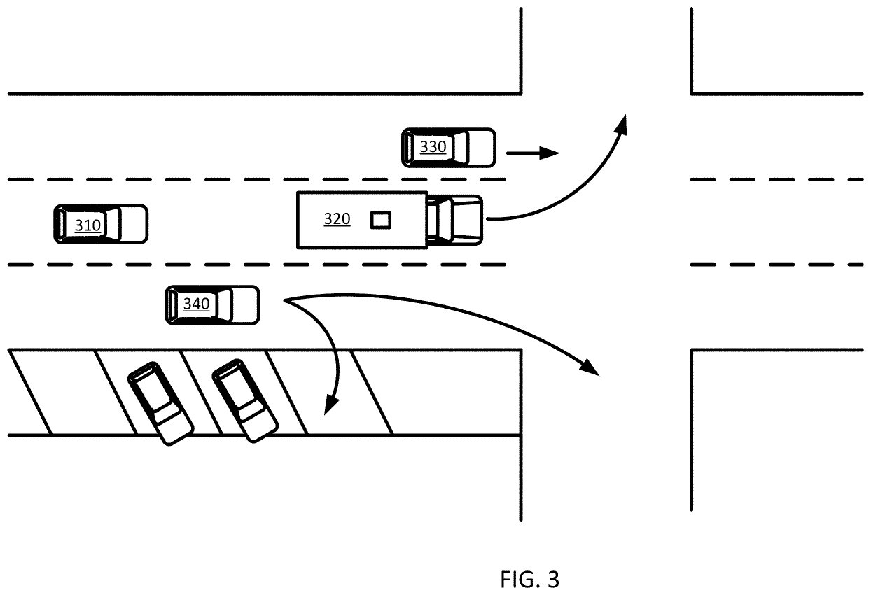

FIG. 3 depicts an example scenario where a user may ask a question about the behavior of another vehicle. In FIG. 3, the user is a passenger in vehicle 310. There are three other vehicles 320, 330, 340 on the roadway. A question may be, for example, “why is that truck slowing down?” The device 122 may be able to determine that the truck 320 is attempted to make an illegal left-hand turn from the middle lane but is blocked by vehicle 330. Similarly, the user may ask “Why is that driver speeding up?” The device 122 may determine from the context of the question and the environment that the user is referring to vehicle 330. The device 122 may determine that the vehicle 330 is most likely speeding up because it is trying to pass the truck 320 which is making an illegal left-hand turn. The user may also ask about the vehicle 340, for example “why is that vehicle turning?” There are potentially two different answers, e.g. the vehicle 340 is attempting to park or it is going to take a right at the next intersection. The device 122 may acquire sensor data, parking data, V2V data and rank each answer and provide the highest ranked answer.

In an embodiment, the user inquiry is received using a microphone. The device 122 may be configured for speech recognition using one or more trained speech recognition systems or applications. The device 122 may be configured for voice recognition to identify a speaker. The device 122 may be configured to understand a fixed set of commands or questions. Alternatively, the device 122 may use natural-language speech recognition to identify the inquiry. The device 122 may be configured with customized speech recognition that is programmed or customized with certain domain specific terms that relate to the roadway environment. The device 122 may be configured to understand multiple languages and different regional terms for different objects in the road, e.g. truck vs. lorry. The user inquiry may be processed by the device 122 and stored in a memory as text. Additional data relating to the text, for example, the speaker, the location of the speaker, any emphasis, or other contextual data may also be acquired and stored.

In an embodiment, the user inquiry is based on a user's recognized emotion and expressions. The device 122 may be configured to capture images of the interior of the vehicle and, for example, of the passengers. The device 122 may be configured to identify emotion or expression of a user. For example, the device 122 may continuously monitor the interior of a vehicle. During the monitoring, the device 122 may detect that a user looked surprised about a maneuver around the car or other nearby event that the device 122 needs to explain it (if possible). Monitoring of a user may be used in conjunction with the microphone in order to provide additional context to an inquiry.

In an embodiment, the user inquiry is based on a recognizable illegal maneuver detected by the vehicle. The device 122 may identify a maneuver by another vehicle that is erratic or illegal and may proactively warn a user to not to follow the vehicle that is infringing traffic rules. An example may be where a device 122 identifies another vehicle using the shoulder of a highway to bypass traffic. The device 122 may proactively identify that the other vehicle is performing an illegal maneuver. The device 122 may indicate this to a user or passenger of the vehicle.

The user inquiry and any contextual information or data relating to the user inquiry may be stored by the device 122 along with any answers and data provided as described below. The device 122 may be configured to anticipate inquiries and proactively provide unsolicited answers. The device 122 may be personalized for a user, a vehicle, a type of vehicle, etc.

At act A120, the device 122 analyzes sensor data acquired by the vehicle for a period of time preceding the inquiry. The period of time may be, for example, 5 seconds, 10 seconds, 20 seconds, or longer. Certain data may be maintained for longer periods of time, while other data may be acquired and discarded by the device 122 almost immediately. In order to better understand what is happening around the vehicle the device 122 may access data from multiple sensors (camera, LIDAR, radars, etc.). The device 122 may communicate with other devices 122 or systems to get a more detailed perception of the environment and access to data that this car would not necessarily have, though, for example, vehicle to vehicle (V2V) communication to retrieve data from other nearby vehicles, V2I communication to retrieve data from the infrastructure (e.g. timing of the past red light, emergency vehicles), or V2x communication.

During normal operation, the vehicle and device 122 may collect a large amount of data regarding the roadway, other vehicles, environmental conditions, etc. This data may be acquired from active sensors, passive sensors, or databases such as the geographic database 123. Information may also be provided from other vehicles or devices 122 on the roadway or the mapping system 121. As an example, the inputs/sensor data may include but are not limited to road attributes (width, size, directionality, etc.), traffic data, on street parking conditions around delivery addresses, parking churn rate, population model prediction, exterior vehicle sensors (proximity, etc.), weather data, vehicles' maneuverability, line of sight/visibility, mobility graphs, parking restrictions, on street parking availability from real-time parking street management systems, lane attributes, location data for emergency infrastructure (such as fire hydrants), nearby event data (such as street fairs, festivals, etc. . . . ), adjacent lane types (such as bicycle lanes), among other data. Certain data may be acquired in real time. Certain data may be stored in the HD map/geographic database 123. The mapping system 121 may be configured to acquire and process data relating to roadway or vehicle conditions from multiple devices 122 and store the data in the geographic database 123. For example, the mapping system 121 may receive and input data such as vehicle data, user data, weather data, road condition data, road works data, traffic feeds, etc. The data may be historical, real-time, or predictive.

Stored data may be used by the device 122 in addition with real-time data when operating the vehicle. For example, the device 122 may use certain data from the HD map or geographic database when operating on the roadway such as the roadway attributes, lane data, and traffic data. The device 122 may use this data with real time image data, GPS data, radar, lidar, sonar, odometry, and/or IMU data to safely operate a vehicle on the roadway.

The device 122 collects this real-time data from input devices such as cameras, radar, and lasers to allow the car to identify the environment and the objects around the vehicle. The device 122 classifies objects in data from these input devices and then determines its positions. The device 122 performs object detection in real-time in order to detect objects approaching quickly and avoid them. The data obtained can be combined with HD map data and geographic database data to identify objects like traffic lights, vehicles, and pedestrians to help the device 122 make decisions in real time.

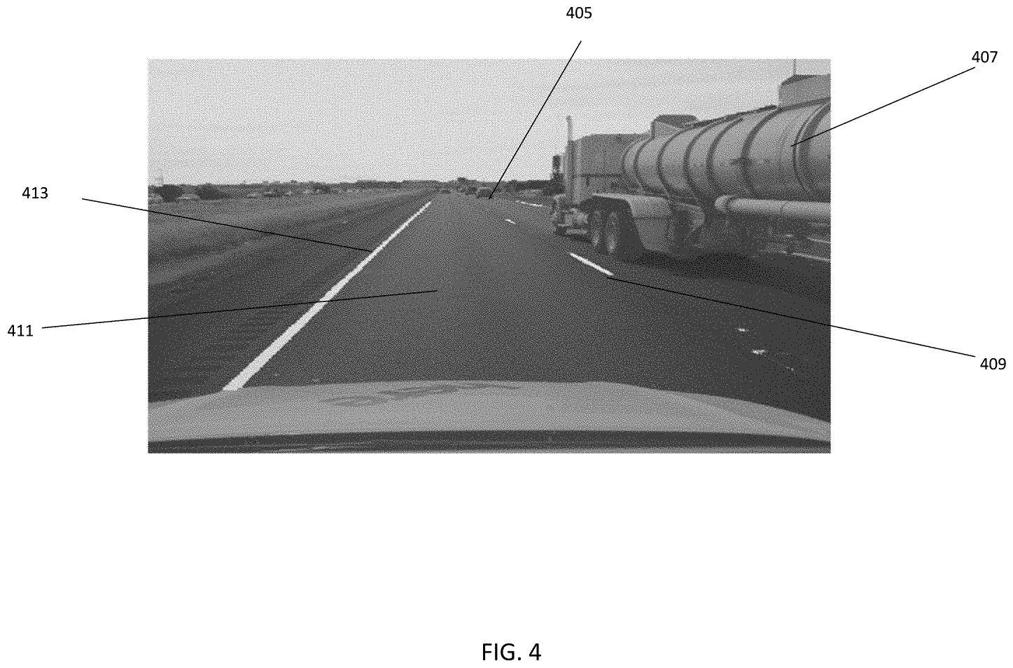

FIG. 4 depicts an example of computer vision for an autonomous vehicle. The device 122 captures an image of the environment around the vehicle and then segments the image. The device 122 performs object recognition to identify each of the objects such as the truck 407, car 405, centerline 409, lane boundary 413, and drivable space 411. The device 122 learns to operate a vehicle by identifying these objects and roadway features and then performing various actions in response. The device 122 may use this data (real-time and geographic) to generate predictions for what the device 122 expects to happen. For example, the device 122 may be able to predict that another vehicle will take a left turn fifty meters down the road based on the current location and maneuvers of the other vehicle. The device 122 may also identify a turn signal, receive data using V2V regarding the destination of the other vehicle, identify that the other vehicle is slowing down, etc. The predictions may be used by the device 122 to generate commands for the vehicle to avoid obstacles or dangerous situations by proactively performing actions. The predictions may also be used in certain embodiments to assist the device 122 in providing answers to user's questions.

The acquired data may be stored by the device 122 for a certain amount of time. The device 122 analyzes the sensor data acquired by the vehicle for a period of time preceding the inquiry. The period of time may be, for example, 5 seconds, 10 seconds, 20 seconds, or longer. The device 122 may analyze the raw or unprocessed data. Alternatively, the device 122 may use sensor data that has been processed by the device 122 in a normal or typical operation of providing instructions to an autonomous vehicle. As an example, typically in an autonomous or semi-autonomous vehicle, the device 122 is configured to acquire sensor data, analyze the sensor data, and generate commands or instructions for the vehicle based on the analysis. In an embodiment, the device 122 may perform this analysis in the normal operation of the vehicle, but also include additional sensor or mapping data in order to analyze the environment around the vehicle to answer the inquiry. As an example, in a typical operation, the device 122 may not analyze or acquire certain data because the data is not relevant to the operation of the vehicle. However, in order to provide an answer to an inquiry about other vehicles, the device 122 may require additional data that broadens out the horizon.

The device 122 analyzes the sensor data and identifies or predicts a plurality of possible actions by other vehicles or objects relating to the inquiry. The device 122 identifies objects or other vehicles around the device 122 using, for example, image sensors, radar, V2V communication, LIDAR, etc. The device 122 uses information from, for example, the geographic database and HD map to identify or predict possible actions or maneuvers performed by the other vehicles/objects. In an embodiment, the device 122 may then score or rank each action to determine which action is most likely related to the inquiry. As an example, if the inquiry asks about “a truck” then the device 122 may use this contextual information and analyze the sensor data to identify any trucks in the vicinity of the vehicle. Once identified, the device 122 then analyzes sensor data to determine if there were any actions performed by the truck(s) that match up with the inquiry. The device 122 may rank these actions higher than, for example, an action performed by a typical car. The device 122 may also use the identified actions to understand the inquiry. For example, the device 122 may receive an inquiry but not understand if it was related to the actions of a truck or a bus. By analyzing the environment around the vehicle, the device 122 may identify that a truck performed an erratic operation, but the bus did not. As such, the action of the truck may be ranked higher as a possible answer to the inquiry. The context of the environment may thus be used to understand the inquiry and may further the determination of which action is relevant.

In an embodiment, the identification of objects is performed using object recognition techniques. Object detection/recognition is a two-part process, image classification and then image localization. The device 122 performs image classification by determining what the objects in the image are, like a car or a person. The device 122 performs image localization by identifying the specific location of these objects. Object detection may be performed by any available methods, for example image segmentation or using machine learning or deep learning such as Neural networks, convolutional neural networks (CNNs), and deep CNNs (DCNNs) among other network types.

In an embodiment, the actions are identified using the predictive capabilities of the device 122. The device 122 may use multiple different algorithms or trained networks to predict or generate actions on the roadway. These networks, for example may identify all of the drivable space around the vehicle, regardless of whether it's in the car's lane or in neighboring lanes, highlight the drivable path ahead of the vehicle, even if there are no lane markers, detect lane lines and other markers that define the car's path, perceive other cars on the road, pedestrians, traffic lights and signs, detects conditions where the vehicle must stop and wait, such as intersections, among other functions. Each of these algorithms or networks input the sensor data and output instructions or predictions for the vehicle to operate with. The instructions or predictions may be used as a basis for the possible events around the vehicle that may relate to the inquiry.

If it is not clear, the device 122 may determine and rank the possible events around the vehicle to determine which would require an explanation. A simple question like “what is that car doing?” may lead to multiple different explanations. The determined actions from the analysis of the sensor data, mapping data provided by the mapping system 121 or geographic database 123, and contextual information from the inquiry may be used to rank the possible events to determine which event/action is most relevant and therefore most likely to be an answer for the inquiry.

In an embodiment, the device 122 may perform a semantic analysis of the inquiry to determine its meaning and contextual information. The semantic analysis of starts by inputting the text from the inquiry to identify the real meaning of any text. The device 122 identifies the text elements and assigns the elements to their logical and grammatical role. The device 122 analyzes context in the text and analyzes the text structure to accurately disambiguate the proper meaning of words that have more than one definition. The device 122 may use attention mechanisms for speech recognition and analysis. An attention mechanism determines how much each word of the input should contribute to the final output. In many applications, for instance, the names of entities (“truck”, “bus”, “blue car”) are more important than articles (“a”, “the”) or prepositions (“to”, “of”); an attention mechanism would thus assign them greater weight. Alternative speech recognition or methods of analysis may be used such as neural networks or machine learning. The result of the analysis of the inquiry is contextual data or information which may be used to determine or rank the relevant action or object.

The result of the analysis of the sensor data is a list of possible relevant actions/objects. The actions/objects may be ranked in light the textual or contextual information from the inquiry and mapping data. In case of multiple events ranked equal, the system might need to disambiguate “Do you mean X or Y?” Certain inquires or sensor data may be prioritized. For example, a user may manually define a priority order for which actions or objects are more important. In addition, implicit query data may be assigned a higher priority than explicit queries or, for example, queries involving pedestrians may rank higher.

In an embodiment, the ranking or scoring may use a feedback system. Each answer is given a point score based on the number of times a device 122 provides the answer and a quality of the answer based on user feedback. The device 122 or mapping system 121 may store possible answers to various inquiries. If a possible action does not match up with a possible answer, the action may be ranked or scored lower. As an example, the device 122 may store various answers to a user question “why is that car allowed to park there?” Stored answers may, for example, include different responses related to the type of vehicle, the type of parking, the time of day, the state of the environment (weather), etc. If none of these stored answers are valid in light of the sensor data, mapping data, and contextual data, then another answer may be derived.

At act A130 the device 122 generates an answer to the inquiry based on the analysis of the sensor data/mapping data and contextual information from the inquiry. As described above, the device 122 is configured to understand the user's query based on the contextual information of the inquiry, analysis of the environment through sensors and V2V, and mapping information of a time period preceding the inquiry. The output of the analysis is a list (possibly ranked) of actions that were identified and deemed relevant in light of the contextual information and the mapping information. The device 122 is configured to match one or more of these actions to the inquiry received at act A110.

Generating the answer may include providing a natural language response with an explanation derived from the sensor and mapping data. For example, it may not be sufficient for the device 122 to just identify an action. Rather, the device 122 is configured to phrase the action so that the answer makes sense and provides information to the user. In an example, the inquiry may relate to a vehicle parking. The device 122 may identify a vehicle parking nearby from sensor data, identify parking restrictions from a mapping database, identify parking privileges of the vehicle by V2V, and determine that this action relates to the inquiry. The answer may be, for example, that the car has special parking privileges. The answer may be phrased in light of all the information. The device 122 may generate an answer as such “The red car is able to park in that restricted area because the red car has special parking privileges due to the operator being an employee.”

At act A140, the device 122 provides the answer to the inquiry to the user. The device 122 is configured to generate an output in an audio or visual form as a response to the inquiry.

Several examples of inquiries and answers are provided below:

Q1: Why is this truck/van ahead of me not moving anymore?

Reply: Because car before is turning but you cannot see it now.

Q2: Why is this lane currently empty and the other one full?

Reply: Because it will turn in 200 m and people anticipate it.

Q3: Why is this car accelerating so much now?

Reply: Because we are on a German highway and there was an end of speed limitation 300 m ago.

Q4: Why is this car parking here although it is said no parking allowed?

Reply: Because it is a doctor who has special parking rights.

Q5: Why is this car not moving at the green light?

Reply: Because it has stalled.

Q6: Why is this car not turning right now?

Reply: Because it waits for the arriving bike to cross first.

Q7: Why is this car pulling on the side now for no reason?

Reply: Because an ambulance is coming.

Q8: Why is this car going so slowly on that road?

Reply: Because the car ahead has reported an animal on the road.

In an embodiment, the device 122 is configured to provide a follow-up answer to a user. In one scenario, the device 122 may have provided an incorrect answer to the user's inquiry, for example by identifying the wrong action. The user may correct the device 122 and ask for a different answer. In addition, the device 122 may be configured to provide additional information about an action. For example, for the query Why is this car not moving at the green light? the device 122 may reply: Because the vehicle has mechanical problems. The user may ask “what sort of problems?” and the device 122 may reply: Engine problems.

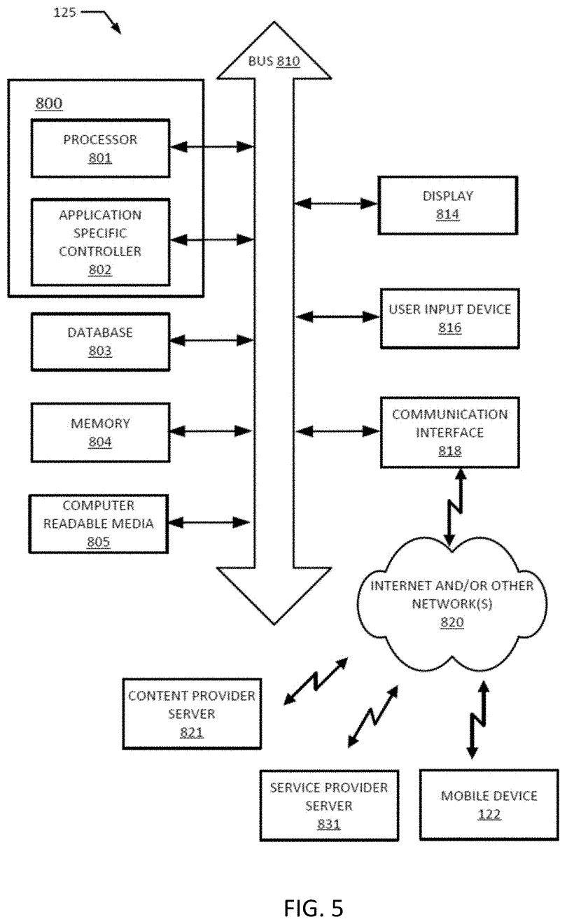

As described above, the server 125 may acquire and process data for the geographic database 123 and device 122. The server 125 may also provide support for analyzing the data and generating an answer. FIG. 5 depicts an example server 125 of the mapping system of FIG. 1. The server 125 is configured to acquire data, analyze the data, and generate explanations for actions determined from the acquired data. The server 125 may include a bus 810 that facilitates communication between a controller that may be implemented by a processor 801 and/or an application specific controller 802, which may be referred to individually or collectively as controller 800, and one or more other components including a database 803, a memory 804, a computer readable medium 805, a display 814, a user input device 816, and a communication interface 818 connected to the internet and/or other networks 820. The contents of database 803 are described with respect to database 123. The server-side database 803 may be a master database that provides data in portions to the database of the mobile device 122. Additional, different, or fewer components may be included.

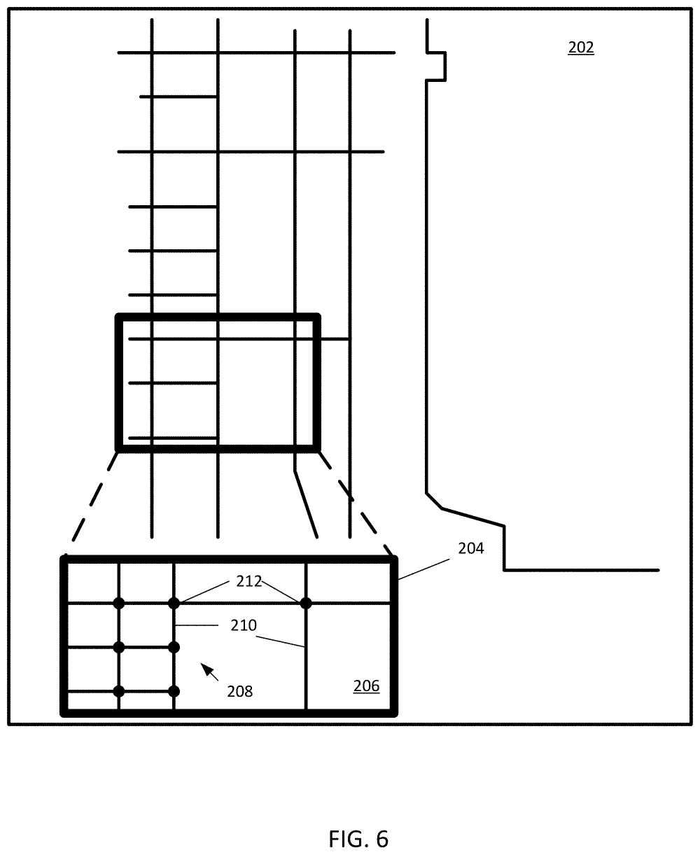

The geographic database 123 is configured to store information for use in analyzing the environment around a vehicle. The information may be stored as geographic data that describes features and limitations of the roadway. The information may be historical data, real-time data, or predicted or derived data. The geographic database 123 includes information about one or more geographic regions. FIG. 6 illustrates a map of a geographic region 202. The geographic region 202 may correspond to a metropolitan or rural area, a state, a country, or combinations thereof, or any other area. Located in the geographic region 202 are physical geographic features, such as roads, points of interest (including businesses, municipal facilities, etc.), lakes, rivers, railroads, municipalities, etc.

FIG. 6 further depicts an enlarged map 204 of a portion 206 of the geographic region 202. The enlarged map 204 illustrates part of a road network 208 in the geographic region 202. The road network 208 includes, among other things, roads and intersections located in the geographic region 202. As shown in the portion 206, each road in the geographic region 202 is composed of one or more road segments 210. A road segment 210 represents a portion of the road. Road segments 210 may also be referred to as links. Each road segment 210 is shown to have associated with it two nodes 212; one node represents the point at one end of the road segment and the other node represents the point at the other end of the road segment. The node 212 at either end of a road segment 210 may correspond to a location at which the road meets another road, i.e., an intersection, or where the road dead ends.

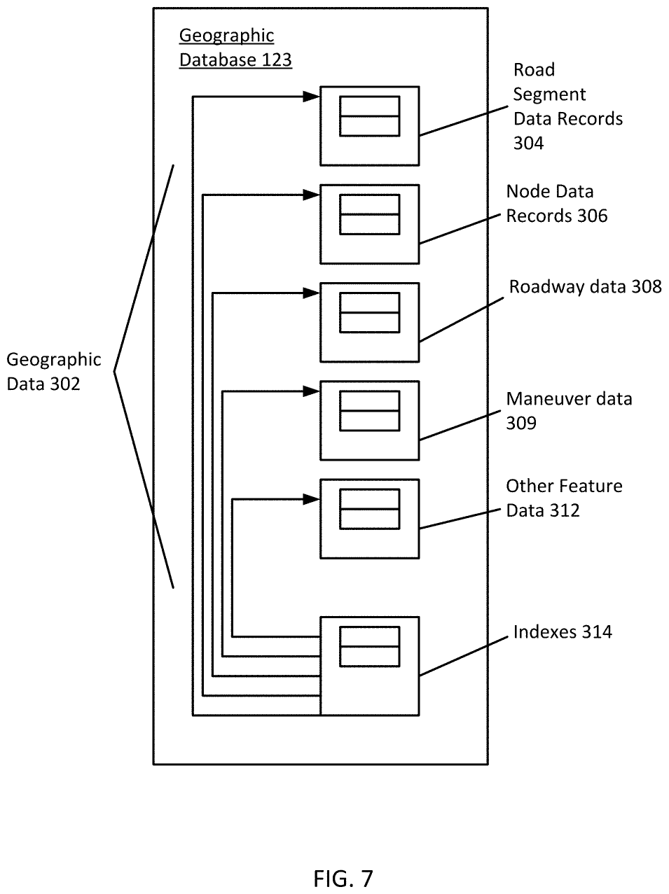

As depicted in FIG. 7, in one embodiment, the geographic database 123 contains geographic data 302 that represents some of the geographic features in the geographic region 202 depicted in FIG. 3. The data 302 contained in the geographic database 123 may include data that represent the road network 208. In FIG. 7, the geographic database 123 that represents the geographic region 202 may contain at least one road segment database record 304 (also referred to as “entity” or “entry”) for each road segment 210 in the geographic region 202. The geographic database 123 that represents the geographic region 202 may also include a node database record 306 (or “entity” or “entry”) for each node 212 in the geographic region 202. The terms “nodes” and “segments” represent only one terminology for describing these physical geographic features, and other terminology for describing these features is intended to be encompassed within the scope of these concepts.

The geographic database 123 may include feature data 308-312. The feature data 312 may represent types of geographic features. For example, the feature data may include roadway data 308 including signage data, lane data, traffic signal data, physical and painted features like dividers, lane divider markings, road edges, center of intersection, stop bars, overpasses, overhead bridges etc. The roadway data 308 may be further stored in sub-indices that account for different types of roads or features. The maneuver data 309 may include or describe possible actions or maneuvers. The feature data 312 may include point of interest data or other roadway features. The point of interest data may include point of interest records comprising a type (e.g., the type of point of interest, such as restaurant, fuel station, hotel, city hall, police station, historical marker, ATM, golf course, truck stop, vehicle chain-up stations etc.), location of the point of interest, a phone number, hours of operation, etc.

The geographic database 123 also includes indexes 314. The indexes 314 may include various types of indexes that relate the different types of data to each other or that relate to other aspects of the data contained in the geographic database 123. For example, the indexes 314 may relate the nodes in the node data records 306 with the end points of a road segment in the road segment data records 304.

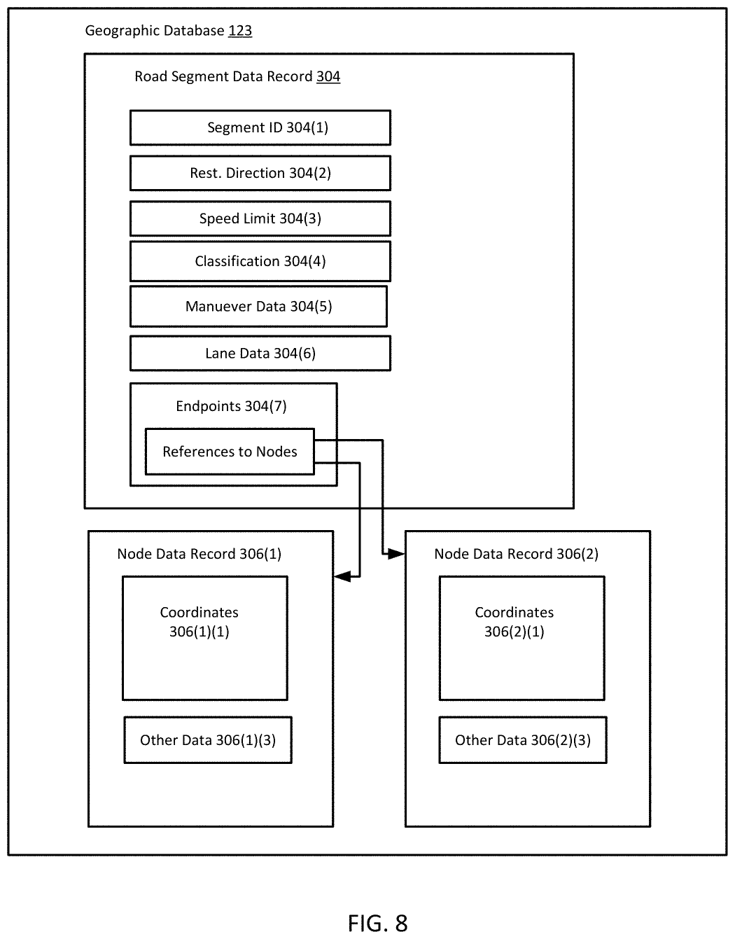

FIG. 8 shows some of the components of a road segment data record 304 contained in the geographic database 123 according to one embodiment. The road segment data record 304 may include a segment ID 304(1) by which the data record can be identified in the geographic database 123. Each road segment data record 304 may have associated with the data record, information such as “attributes”, “fields”, etc. that describes features of the represented road segment. The road segment data record 304 may include data 304(2) that indicate the restrictions, if any, on the direction of vehicular travel permitted on the represented road segment. The road segment data record 304 may include data 304(3) that indicate a speed limit or speed category (i.e., the maximum permitted vehicular speed of travel) on the represented road segment. The road segment data record 304 may also include data 304(4) indicating whether the represented road segment is part of a controlled access road (such as an expressway), a ramp to a controlled access road, a bridge, a tunnel, a toll road, a ferry, and so on. The road segment data record 304 may also include data 304(5) for possible actions or maneuvers and lane data 304(6) that describes the lanes. The road segment data record 304 also includes data 304(7) providing the geographic coordinates (e.g., the latitude and longitude) of the end points of the represented road segment. In one embodiment, the data 304(7) are references to the node data records 306 that represent the nodes corresponding to the end points of the represented road segment. The road segment data record 304 may also include or be associated with other data 304(7) that refer to various other attributes of the represented road segment. The various attributes associated with a road segment may be included in a single road segment record or may be included in more than one type of record which cross-references to each other. For example, the road segment data record 304 may include data identifying what turn restrictions exist at each of the nodes which correspond to intersections at the ends of the road portion represented by the road segment, the name or names by which the represented road segment is known, the street address ranges along the represented road segment, and so on.

FIG. 8 also depicts some of the components of a node data record 306 which may be contained in the geographic database 123. Each of the node data records 306 may have associated information (such as “attributes”, “fields”, etc.) that allows identification of the road segment(s) that connect to it and/or a geographic position (e.g., latitude and longitude coordinates). For the embodiment shown in FIG. 8, the node data records 306(1) and 306(2) include the latitude and longitude coordinates 306(1)(1) and 306(2)(1) for their node. The node data records 306(1) and 306(2) may also include other data 306(1)(3) and 306(2)(3) that refer to various other attributes of the nodes.

The geographic database 123 may be maintained by a content provider (e.g., a map developer). By way of example, the map developer may collect geographic data to generate and enhance the geographic database 123. The map developer may obtain data from sources, such as businesses, municipalities, or respective geographic authorities. In addition, the map developer may employ field personnel to travel throughout the geographic region to observe features and/or record information about the roadway. Remote sensing, such as aerial or satellite photography, may be used. The database 123 is connected to the server 125. The geographic database 123 and the data stored within the geographic database 123 may be licensed or delivered on-demand. Other navigational services or traffic server providers may access the traffic data stored in the geographic database 123. Data for an object or point of interest may be broadcast as a service.

The memory 804 and/or the computer readable medium 805 may include a set of instructions that can be executed to cause the server 125 to perform any one or more of the methods or computer-based functions disclosed herein. In a networked deployment, the system of FIG. 7 may alternatively operate or as a client user computer in a client-server user network environment, or as a peer computer system in a peer-to-peer (or distributed) network environment. It can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. While a single computer system is illustrated, the term “system” shall also be taken to include any collection of systems or sub-systems that individually or jointly execute a set, or multiple sets, of instructions to perform one or more computer functions.

The server 125 may be in communication through the network 127/820 with a content provider server 821 and/or a service provider server 831. The server 125 may provide mapping data to the content provider server 821 and/or the service provider server 831. The content provider may include device manufacturers that provide location-based services associated with different locations POIs that users may access. The server 125 may be configured to search the geographic database 123 for answers to queries by a user. The server 125 may be configured to learn to identify objects and actions. The server 125 may be configured to interpret queries. The server 125 may be configured to provide data to a device 122 to assist the device in understanding an inquiry, analyzing data, and providing a response.

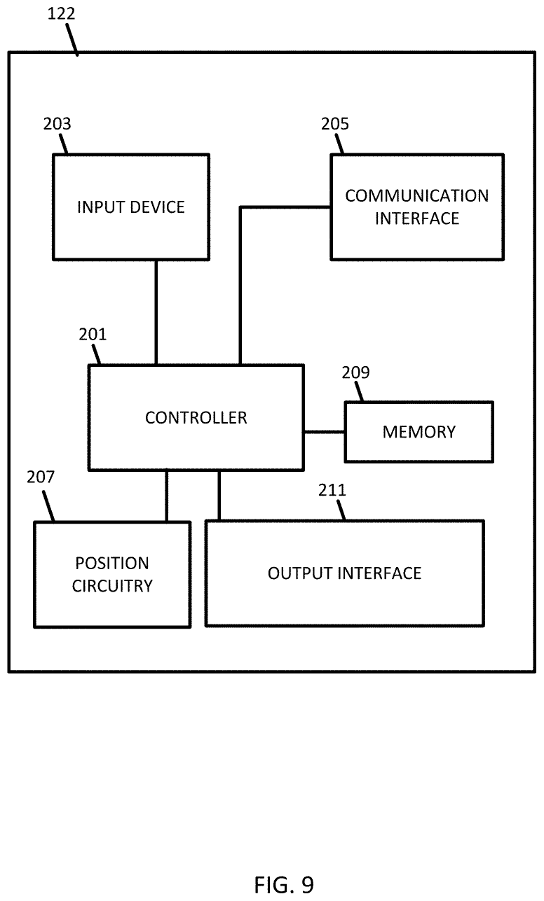

FIG. 9 illustrates an example device 122 of the system of FIG. 1 that may be configured to acquire sensor data for an environment around a vehicle, receive an inquiry from a user interface, determine a context of the inquiry based on the sensor data, generate an answer to the inquiry using the context, the sensor data, and geographic data stored in a geographic database, and provide the answer with a user interface. The device 122 may be configured to collect, transmit, receive, process, or display data. The device 122 may also be referred to as a probe 122, a mobile device 122, a data source 122, or a navigation device 122. The device 122 includes a controller 201, a memory 209, an input device 203, a communication interface 205, position circuitry 207, and an output interface 211. Additional, different, or fewer components are possible for the device 122. The device 122 may be smart phone, a mobile phone, a personal digital assistant (PDA), a tablet computer, a notebook computer, a stationary computer, a IoT device, a remote sensor, a personal navigation device (PND), a portable navigation device, and/or any other known or later developed device that is configured to collect, transmit, receive, process, or display data. In an embodiment, a vehicle may be considered a device 122, or the device 122 may be integrated into a vehicle. The device 122 may receive or collect data from one or more sensors such as pressure sensors, proximity sensors, infrared sensors, optical sensors, image sensors, among others.

The device 122 may be configured to receive data from a mapping system 121. The device 122 may receive data such as a route that is generated by a mapping system 121. The device 122 may receive mapping data or geographic data that is used for an analysis of the environment around a vehicle to identify or predict actions by other vehicles. The device 122 may generate and/or store the data or instructions in a memory 209. The memory 209 may be a volatile memory or a non-volatile memory. The memory 209 may include one or more of a read only memory (ROM), random access memory (RAM), a flash memory, an electronic erasable program read only memory (EEPROM), or other type of memory. The memory 209 may be removable from the mobile device 122, such as a secure digital (SD) memory card. The memory may contain a locally stored geographic database 123 or link node routing graph. The locally stored geographic database 123 may be a copy of the geographic database 123 or may include a smaller piece. The locally stored geographic database 123 may use the same formatting and scheme as the geographic database 123.

The device 122 may be configured as a navigation system for an autonomous vehicle or a HAD. Assisted driving systems may be incorporated into the device 122. Alternatively, an assisted driving device 122 may be included in the vehicle. The assisted driving device 122 may include memory, a processor, and systems to communicate with the mobile device 122. The assisted driving vehicles may response to geographic data received from geographic database 123 and the server 125. An autonomous vehicle or HAD may take route instructions based on a road segment and node information provided to the navigation device 122. An autonomous vehicle or HAD may be configured to receive routing instructions from a mapping system 121 and automatically perform an action in furtherance of the instructions.

A HAD vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the position of the vehicle and routing instructions.

ADAS vehicles include one or more partially automated systems in which the vehicle alerts the driver. The features may be used to provide alerts to the operator regarding upcoming features. ADAS vehicles may include adaptive cruise control, automated braking, or steering adjustments to keep the driver in the correct lane. ADAS vehicles may issue warnings for the driver based on the position of the vehicle either on a roadway or within a road network system.

The controller 201 may include a general processor, digital signal processor, an application specific integrated circuit (ASIC), field programmable gate array (FPGA), analog circuit, digital circuit, combinations thereof, or other now known or later developed processor. The controller 201 may be a single device or combinations of devices, such as associated with a network 127, distributed processing, or cloud computing. The controller 201 may receive updated instructions, traffic data, or other data. The controller 201 may be configured to acquire sensor data for an environment around the vehicle, receive an inquiry from a user interface, determine a context of the inquiry based on the sensor data, generate an answer to the inquiry using the context, the sensor data, and geographic data stored in a geographic database, and provide the answer with a user interface. In an embodiment, the device 122 is configured to store sensor data and analysis from the sensor data in a searchable database. The searchable database may be semantically organized/indexed. A Semantic search may be used to improve a search accuracy by understanding the intent of a query and the contextual meaning of terms as they appear in the searchable dataspace.

The communication may be performed using a communications interface 205. The communications interface 205 may include any operable connection. An operable connection may be one in which signals, physical communications, and/or logical communications may be sent and/or received. An operable connection may include a physical interface, an electrical interface, and/or a data interface. The communications interface 205 provides for wireless and/or wired communications in any now known or later developed format. The communications interface 205 may include a receiver/transmitter for digital radio signals or broadcast mediums.

The communications may include information related to feature data, routing, or other navigation service. The information may be displayed to a user or occupant of the vehicle using an output interface 211. The output interface 211 may be a liquid crystal display (LCD) panel, light emitting diode (LED) screen, thin film transistor screen, or another type of display. The output interface 211 may also include audio capabilities, or speakers.

The input device 203 may be one or more buttons, keypad, keyboard, mouse, stylist pen, trackball, rocker switch, touch pad, voice recognition circuit, or other device or component for inputting data to the device 122. The input device 203 and the output interface 211 may be combined as a touch screen, that may be capacitive or resistive. There may be different reasons for the device 122 to trigger and compute an explanation related to a vehicle's surroundings: The input device 203 may detect that the user has asked proactively what has happened. The input device may trigger the process based on a user's recognized emotion and expressions, i.e. the user looked so surprised about a maneuver around the car or other nearby event that the system needs to explain it. The device 122 may forgot the input device 203 and start the process based on a recognizable illegal maneuver detected by the vehicle, in which case the system may proactively warn the driver not to follow this car infringing traffic rules.

The device 122 may be configured to use various data to determine which “event” (i.e. maneuver, sudden break, car not moving) the user is interested in when making an implicit (surprised facial expression) or explicit (when asking directly) query to the system. For example, the input device 203 may use gaze tracking to determine which direction the user is looking at. The input device 203 may use a microphone to identify which even the user is directly referring to, e.g. “Why is this car in front not moving?” The device 122 may use video recognition and segmentation. Alternatively, if not specified, the device 122 may be configured to determine and rank the possible events around the vehicle which would require an explanation. In case of multiple events ranked equal, the device 122 may need to ask the user, for example, using the output interface 211 to ask, “Do you mean X or Y?”

The controller 201 and the output interface 211 may be configured to render and present a user interface to a user. The controller may be configured to proactively provide answers to unspoken questions or queries using the user interface. For example, the controller may provide explanations for all event or all erratic behaviors that are occurring around the vehicle by providing a stream or feed of textual or visual descriptions.

In an embodiment, the device 122 or controller 201 may be configured with a neural network that is trained to identify answers to inquiries given sensor data. The network may be defined as a plurality of sequential feature units or layers. Sequential is used to indicate the general flow of output feature values from one layer to input to a next layer. Sequential is used to indicate the general flow of output feature values from one layer to input to a next layer. The information from the next layer is fed to a next layer, and so on until the final output. The layers may only feed forward or may be bi-directional, including some feedback to a previous layer. The nodes of each layer or unit may connect with all or only a sub-set of nodes of a previous and/or subsequent layer or unit. Skip connections may be used, such as a layer outputting to the sequentially next layer as well as other layers. Rather than pre-programming the features and trying to relate the features to attributes, the deep architecture is defined to learn the features at different levels of abstraction based on the input data. The features are learned to reconstruct lower level features (i.e., features at a more abstract or compressed level). For example, features for reconstructing an image are learned. For a next unit, features for reconstructing the features of the previous unit are learned, providing more abstraction. Each node of the unit represents a feature. Different units are provided for learning different features.

Various units or layers may be used, such as convolutional, pooling (e.g., max pooling), deconvolutional, fully connected, or other types of layers. Within a unit or layer, any number of nodes is provided. For example, 100 nodes are provided. Later or subsequent units may have more, fewer, or the same number of nodes. In general, for convolution, subsequent units have more abstraction. For example, the first unit provides features from the image, such as one node or feature being a line found in the image. The next unit combines lines, so that one of the nodes is a corner. The next unit may combine features (e.g., the corner and length of lines) from a previous unit so that the node provides a shape indication. For transposed convolution to reconstruct, the level of abstraction reverses. Each unit or layer reduces the level of abstraction or compression.

The network may be trained by inputting questions and sensor data into the network which is configured to output a classification or answer to the input question. The answers are scored against ground truth data, the difference therein used to adjust weights in the units or layers of the network. By repeatedly inputting and adjusting the network, the network learns to provide better answers to questions. The output is a trained network that can be implemented in the device by the controller 201. The device 122 may store data for each question and answer, which data may be used as training data for updating the network or training other networks.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in the specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

As used in the application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a GPS receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may be a non-transitory medium such as a ROM, RAM, flash memory, etc. The processor and the memory may be supplemented by, or incorporated in, special purpose logic circuitry.

To provide for interaction with a user, embodiments of the subject matter described in this specification may be implemented on a device having a display, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the subject matter described in this specification may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the subject matter described in this specification, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A method for analyzing an environment around a vehicle to be able to provide an explanation about what is happening in the environment, the method comprising:
receiving, by a processor, an inquiry from a user of the vehicle, the inquiry related to a behavior of another vehicle in a vicinity of the vehicle;
analyzing, by the processor, sensor data acquired by the vehicle for a period of time preceding the inquiry;
generating, by the processor, an answer to the inquiry based on contextual information of the inquiry, geographic map data, and the analysis of the sensor data; and
providing, by the processor, the answer to the inquiry.

2. The method of claim 1, wherein receiving the inquiry comprises:
receiving, by the processor, audio input from a user interface;
converting, by the processor, the audio input to text; and
analyzing, by the processor, the text to determine a meaning of the text.

3. The method of claim 2, further comprising:
acquiring, by the processor, sensor data relating to the user;
wherein the sensor data is used to determine a meaning of the text.

4. The method of claim 2, wherein analyzing comprises:
mapping, by the processor, the text to one or more stored queries.

5. The method of claim 1, wherein the receiving the inquiry comprises:
detecting, by the processor, a facial expression of the user;
determining, by the processor, an implicit inquiry based on a state of the environment;

6. The method of claim 1, wherein the behavior of the other vehicle comprises erratic driving behavior.

7. The method of claim 6, wherein the erratic driving behavior is an illegal maneuver.

8. The method of claim 1, further comprising:
receiving, by the processor, additional data from other vehicles or roadway sources, wherein the additional data is analyzed with the sensor data.

9. The method of claim 1, wherein analyzing the sensor data comprises determining and ranking possible actions around the vehicle, wherein an action is ranked lower if the action is less related to the inquiry.

10. The method of claim 1, wherein the answer is provided in an audio or visual form.

11. A system for providing answers to user inquiries in a first vehicle, the system comprising:
a geographic database configured to store map data for a roadway network;
one or more sensors configured to acquire sensor data for an environment around the first vehicle;
a user interface configured to receive an inquiry from a user of a first vehicle regarding an operation of a second vehicle in a vicinity of the first vehicle and provide an answer; and
a controller configured to analyze the inquiry, the sensor data, and the map data and generate the answer to the inquiry based on the analysis.

12. The system of claim 11, wherein the one or more sensors comprise at least one of an image sensor, LIDAR, or Radar.

13. The system of claim 11, wherein the user interface is configured to receive the inquiry by detecting an expression of the user.

14. The system of claim 11, wherein the controller is configured to analyze the inquiry, the sensor data, and the map data to identify possible actions related to the inquiry, rank the possible actions based on the analysis, and generate the answer based on the rank of the possible actions.

15. The system of claim 11, further comprising:
a vehicle to vehicle transmission system configured to receive and transmit vehicle data between vehicles on the roadway, wherein the controller is further configured to further use the vehicle data to generate the answer.

16. The system of claim 11, wherein the second vehicle is being operated illegally.

17. The system of claim 11, further comprising:
one or more interior sensors configured to monitor the interior of the vehicle and provide user data to the controller to provide context for the analysis of the inquiry.

18. An apparatus for providing a response to a user query about what is happening around a vehicle, the apparatus comprising:
at least one processor; and
at least one memory including computer program code for one or more programs; the at least one memory configured to store the computer program code configured to, with the at least one processor, cause the at least one processor to:
acquire sensor data for an environment around a mobile device;
receive an inquiry from a user interface;
determine a context of the inquiry based on the sensor data;
generate an answer to the inquiry using the context, the sensor data, and geographic data stored in a geographic database; and
provide the answer with the user interface.

19. The apparatus of claim 18, wherein the inquiry relates to an erratic behavior of another vehicle.

20. The apparatus of claim 18, wherein the inquiry relates to an illegal maneuver by another vehicle.
